(19) United States
(12) Patent Application Publication
(10) Pub. No.: US 2022/0059049 A1
(43) Pub. Date: Feb. 24, 2022

(54) System and Method for Color Calibration

(71) Applicant: Portrait Displays, Inc., Pleasanton, CA (US)

(72) Inventors: Darrell Bird, Seattle, WA (US); James Lund, Kingston, WA (US); Derek Smith, Snohomish, WA (US); Mark Schindler, Seattle, WA (US); Melissa Thompson, Renton, WA (US); Mackenzie Collins, Seattle, WA (US); Josh Palmer, Seattle, WA (US); Mark Ryals, Lake Forest Park, WA (US); Victoria Olivares, Lake Stevens, WA (US); Jason Ramirez, Lake Stevens, WA (US); Larry Allen Heberlein, Seattle, WA (US); Tyler Pruitt, Everett, WA (US); Catherine Meininger, Lynnwood, WA (US); Thomas A Lianza, Bedford, NH (US)

(73) Assignee: Portrait Displays, Inc., Pleasanton, CA (US)

(21) Appl. No.: 17/467,396

(22) Filed: Sep. 6, 2021

Related U.S. Application Data
(63) Continuation-in-part of application No. 16/663,597, filed on Oct. 25, 2019, now Pat. No. 11,114,059.
(60) Provisional application No. 62/754,645, filed on Nov. 2, 2018.

(51) Int. Cl. G09G 5/02; G06F 3/147; H04N 17/02

(52) U.S. Cl. CPC G09G 5/026; G06F 3/147; G09G 2320/0666; G09G 2340/06; G09G 2360/145; H04N 17/02

(57) ABSTRACT

Described herein is a color calibration system and method including a display device including a non-volatile memory, a display screen, and a target sensor. The system and method further can include a computing system in communication with the display device and including a processor, a persistent memory, a temporary memory, and a reference sensor. A calibration matrix can be derived using the reference and target data captured by the target and reference sensors. The calibration matrix can be used to calibrate the target sensor using the calibration matrix.

### CROSS-REFERENCE TO RELATED APPLICATION

The present application is a continuation-in-part of U.S. patent application Ser. No. 16/663,597, entitled “System and Method for Color Calibration,” filed on Oct. 25, 2019, which claims priority benefit to U.S. Provisional Patent Application No. 62/754,645, entitled “System and Method for Color Calibration,” filed on Nov. 2, 2018, each of which are incorporated by reference herein in their entirety.

### FIELD OF THE DISCLOSURE

The present disclosure relates to the system and method of characterizing, calibrating and deploying an embedded filter color measurement device and applying the calibrated data to perform a calibration of the embedded display.

### BACKGROUND OF THE DISCLOSURE

A sensor may not be capable of being used in a tethered application because it may not meet the Luther Condition. In the case of exotic filter designs, there is always some deviation from the design goal that can often lead to increased errors when comparing displays of different spectral content. U.S. Pat. No. 9,163,990 (hereinafter, Lianza) demonstrates an exemplary mechanism to calibrate a device with nominal CMF (color matching function) response for different input spectra. In this example, each device is spectrally characterized, and a specific matrix is derived analytically based upon an assumed collection of arbitrary input spectra. The spectral characterization of the system is time consuming and it is best left to tethered devices that meet a prescribed price/performance value condition. The process described in Lianza is very time consuming and it can fail if the filters are not sufficiently blocked for transmission of energy outside of the visual range of wavelengths as defined by the CIE 1931 color matching functions.

For the specific case of laptop device calibration, U.S. Pat. No. 9,047,807 (hereinafter Kwong) describes a specific location of an arbitrary sensor within a laptop environment. Kwong describes the steps in physically initiating a “closed lid” calibration process and the various indicators used to alert the operator of the various stages of the process, however, does not address the mechanism used to calibrate the internal sensor nor the explicit use of said data from that sensor. In the U.S. Pat. No. 8,441,470 (hereinafter, Hibi) describers a calibration process used and the correction method employed for said process. However, Hibi requires a supplementary Infrared Absorption filter to be placed prior to the Tri-Chromatic X, Y and Z filter. This is needed because it is expensive to add IR blocking to arbitrarily colored filters rather than just adding IR absorption prior to the filter themselves.

### SUMMARY OF THE DISCLOSURE

Described herein are systems, method, and non-transitory computer-readable medium which enables high accuracy color measurement capabilities using a wide range of low cost color filter/sensor combinations. Embodiments of the system and method can include near-infrared measurement data in the computation of the calibration matrix. While using traditional least squares methodology to arrive at a color calibration matrix, the inclusion of the long wavelength data allows for significant improvement in calibration capabilities.

In one embodiments, color calibration systems and methods (and associated non-transitory computer-readable media) are disclosed. A reference sensor generates reference data in response to sensing display data rendered on a display screen of a display device. The display data including luminance patterns and color patterns. A target sensor generates target data in response to the display data rendered on the display screen of the display device. A processor is programmed to derive a linear calibration for the target sensor based on luminance data in the reference data and the target data corresponding to the luminance patterns, derive a calibration matrix based on color data in the reference and target data corresponding to the color patterns, and calibrate the target sensor using the calibration matrix.

The target data can include color data and near infrared data and reference data includes color data. The target sensor can include five channels to capture white, red, green, blue, and near infrared data and the reference sensor can include three channels to capture the red, green, and blue data based on the each of the plurality of reference color patterns rendered on the display screen.

The luminance data in the reference data and target data is generated in response to the plurality of luminance patterns before the plurality of color patterns are rendered on the display screen.

The luminance patterns and the color patterns can be specified according to one or more patch sets to maintain an average operational measurement condition of the display screen based upon a specified distribution of luminance values and differences between the luminance values and a median value for the specified distribution.

A temperature sensor can be associated with at least one of the reference sensor or target sensor. As an example, the temperature sensor is integrally formed the reference sensor or the target sensor. The processor can measure a color drift of the display screen of the display device as a function of an operating temperature of the display screen over a specified period of time and generate a model of the color drift based on the color drift as a function of the operating temperature, wherein the color drift is measured by at least one of the reference sensor or the target sensor and the operating temperature is measured by the temperature sensor. The processor can correct for the color drift using the model before each of the plurality of luminance patterns and each of the plurality of color patterns are render on the display screen.

In one embodiment, a color calibration system can include a display device including a non-volatile memory, a display screen, and a target sensor. The system can further include a computing system in communication with the display device. The computing system can include a processor, a persistent memory, a temporary memory, and a reference sensor. The computing system can be configured to execute an instance of a calibration application.

The computing system can be configured to detect and capture, via the reference sensor, reference data based on display data rendered on the display screen of the display device and store the reference data in the temporary memory. The display device can be configured to detect and capture, via the target sensor, target data based on display data rendered on the display screen of the display device and transmit the target data to the computing system. The computing system can be configured to receive the target data, store the target data in the temporary memory, derive, via the calibration application, a calibration matrix using the reference and target data stored in the temporary memory, and calibrate the target sensor using the calibration matrix.

The target and reference data can include luminance and color data. The display screen of the display device can be configured to display luminance patterns. The target and reference sensors can be configured to capture the luminance data based on the each of the luminance patterns rendered on the display screen. The computing system can be configured to derive, via the calibration application, a linear calibration for the target sensor based on the luminance data captured by the reference and target sensor.

In response to the computing system deriving the linear calibration, the display screen of the display device can be configured to display color patterns. The target and reference sensors can be configured to capture the color data based on each of the color patterns rendered on the display screen. The computing system can be configured to derive, via the calibration application, the calibration matrix based on the color data captured by the target and reference sensors.

The display screen can be a LED, OLED, or LCD display. The display device can be, for example, a television, computer monitor, or mobile device screen. The target sensor can be embedded in a remote control mounted to the display device, the target sensor being in a position to interface with the display screen of the display device. The target sensor can be embedded in a rotating mount coupled to the display device. The target sensor can be magnetically attached to a bezel of the display device. A mirror periscope can include the target sensor and can be embedded in a bezel of the display device.

In one embodiment, a color calibration method can include detecting and capturing, via a reference sensor of a computing system, reference data based on display data rendered on the display screen of the display device. The computing system can be in communication with a display device, and can include a processor, persistent memory, temporary memory and execute an instance of a calibration application. The method can further include storing, via the computing system, the reference data in the temporary memory, detecting and capturing, via a target sensor of the display device including a non-volatile memory and a display screen, target data based on display data rendered on the display screen of the display device, transmitting, via the display device, the target data to the computing system. The method can further include receiving, via the computing system, the target data, storing, via the computing system, the target data in the temporary memory, deriving, via the calibration application executing on the computing system, a calibration matrix using the reference and target data stored in the temporary memory, and calibrating, via the computing system, the target sensor using the calibration matrix.

The target and reference data can include luminance and color data. The method can further include displaying, via the display screen of the display device, a plurality of luminance patterns, capturing, via the target and reference sensors, the luminance data based on the each of the plurality of luminance patterns rendered on the display screen and deriving, via the calibration application of the computing system, a linear calibration for the target sensor based on the luminance data captured by the reference and target sensor. The method can further include displaying, via the display screen of the display device, a plurality of color patterns in response to the computing system deriving the linear calibration, capturing, via the reference and target sensors, the color data based on each of the plurality of color patterns rendered on the display screen and deriving, via the calibration application executing on the computing system, the calibration matrix based on the color data captured by the target and reference sensors.

In one embodiment, the calibration system can include a display device including a processor, non-volatile memory, and a display screen. The display device can be configured to execute an instance of a calibration application. The system can further include one or more target sensors disposed with respect to the display device. The system can further include a computing system in communication with the display device and target sensors and including a processor, a persistent memory, a temporary memory, and a reference sensor. The computing system can be configured to detect and capture, via the reference sensor, reference data based on display data rendered on the display screen of the display device, and transmit the reference data to the display device.

The one or more target sensors can be configured to detect and capture target data based on display data rendered on the display screen of the display device, and transmit the target data to the display device. The display device can be configured to receive the reference data, receive the target data, store the reference and target data in the non-volatile memory, derive, via the calibration application, a calibration matrix using the reference and target data stored in the non-volatile memory, and calibrate the target sensor using the calibration matrix.

Additional advantageous features, functions and benefits of the present disclosure will be apparent from the description which follows, particularly when read in conjunction with the accompanying figures.

### BRIEF DESCRIPTION OF THE DRAWINGS

Features and aspects of embodiments are described below with reference to the accompanying drawings, in which elements are not necessarily depicted to scale.

Exemplary embodiments of the present disclosure are further described with reference to the appended figures. It is to be noted that the various features, steps and combinations of features/steps described below and illustrated in the figures can be arranged and organized differently to result in embodiments which are still within the scope of the present disclosure. To assist those of ordinary skill in the art in making and using the disclosed assemblies, systems and methods, reference is made to the appended figures, wherein:

FIG. 1 depicts a plot of the CIE 1931 color matching functions in accordance with an exemplary embodiment;

FIG. 2 depicts a plot of silicon photodiode responsivity in accordance with an exemplary embodiment;

FIG. 3A depicts responsivity characteristics of an RGB and IR filter set according to an exemplary embodiment;

FIG. 3B illustrate an affect a changing an output of an LCD has on color spectrum and near IR component response;

FIG. 4 is a histogram and cumulative histogram of the luminance of an example 17×17×17 sample data set measurement;

FIG. 5 is a flowchart illustrating a process for generating a median sifted patch set for constant display differences in accordance to an exemplary embodiment;

FIG. 6 is a graph illustrating a relative luminance flux of a white light LED as a function of the forward current;

FIG. 7 is a graph illustrating a typical forward current as a function of a forward voltage for an LED;

FIG. 8 is a graph illustrating a change in the operating temperature as a function of a change in the forward current (x-axis) for an LED;

FIG. 9 is a graph illustrating example changes in luminance over a lifetime of an LED as a function of the junction temperature of the LED;

FIG. 10A is a graph illustrating a luminance flux as a function of wavelength for different forward currents for LEDs;

FIG. 10B is a graph illustrating a luminance flux as a function of substrate temperature for different forward currents for an LED;

FIG. 10C illustrates a trend in color temperature of LEDS for different the forward currents;

FIGS. 11A-B illustrate a block diagram of a color calibration system in accordance to an exemplary embodiment;

FIG. 12 illustrates a process of the color calibration system in accordance to an exemplary embodiment;

FIG. 13 illustrates a process of the color calibration system in accordance to an exemplary embodiment;

FIG. 14 depicts a sensor built in a remote in accordance with an exemplary embodiment;

FIG. 15 depicts a sensor on a rotating mount in accordance with an exemplary embodiment;

FIG. 16 depicts a sensor magnetically attached to a bezel in accordance with an exemplary embodiment;

FIG. 17 depicts an optical mirror arrangement mounted magnetically to a display device in accordance with an exemplary embodiment;

FIG. 18 is a block diagram depicting an exemplary design to minimize viewing angle differences;

FIG. 19 illustrates a block diagram of an example display device for implementing exemplary embodiments of the present disclosure; and

FIG. 20 is a flowchart for implementing the color calibration system according to an exemplary embodiment of the present disclosure.

### DETAILED DESCRIPTION OF THE DISCLOSURE

The exemplary embodiments disclosed herein are illustrative of methods, associated non-transitory computer-readable media, and related systems for color calibration. A display device can include a non-volatile memory, a display screen, and a target sensor. The described system and method can further include a computing system in communication with the display device. The computing system can include a processor, a persistent memory, a temporary memory (e.g., random access memory (RAM)), and a reference sensor. The processor of the computing system can be configured to execute an instance of a calibration application.

The computing system can be configured to detect and capture, via the reference sensor, reference data based on display data rendered on the display screen of the display device and store the reference data in the temporary memory. The display device can be configured to detect and capture, via the target sensor, target data based on display data rendered on the display screen of the display device and transmit the target data to the computing system. The computing system can be configured to receive the target data, store the target data in the temporary memory, derive, via the calibration application, a calibration matrix using the reference and target data stored in the temporary memory, and calibrate the target sensor using the calibration matrix.

The computing system can also be configured to calibrate the display to adjust for drift associated with the backlight of the display. Drift associated with the backlight can negatively impact the calibration of color displays and can negatively impact the operation of a display over time. Calibration of Color Displays often requires many measurements. For instance, the collection of data for a fixed grid 17×17×173 dimensional look up table will require 4,913 measurements. A typical measurement cycle for this number of measurements can easily exceed 3 hours. During this time period a display naturally drifts for a number of reasons such as warm up, display settling time, and natural aging. Display settling time limits the speed of measurements between samples. A test of short-term display drift can utilize high speed measurements of a display from lowest commanded value to highest commanded value as well as from full scale to lowest commanded value. These two tests can be used to determine the measurement settling time for best accuracy of sampled data. The physical nature of the display can also have a determinant effect on the display drift characteristics. For instance, displays that utilize LED backlights are dependent upon the stability of the backlight over the time of the data collection process.

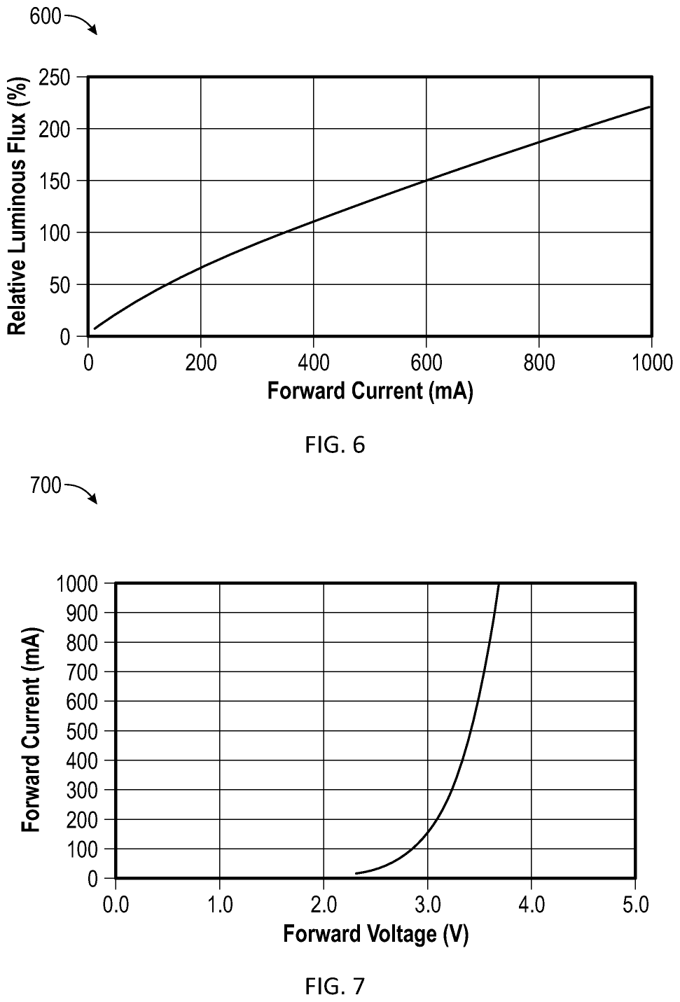

Described herein is a system and method which enables high accuracy color measurement capabilities using a wide range of low cost color filter/sensor combinations. The system and method include near-infrared measurement data in the computation of the calibration matrix and the ability to account for drift in the backlight of the display during the calibration process as well as during a normal operation of the display. When a sensor is embedded in a mobile device or television monitor, the need for precise conformance to Color Matching Function Response is relaxed due to the additive nature of the Red, Green, Blue output of the LCD or OLED under test and the fact that the sensor is used with a single set of primary measurements. As an example, an embedded device can be directly relatable to the measurements of a standard reference device. LCD devices change characteristics as a function of viewing angle, so it is important to manage the viewing angle of the embedded sensor to closely match, or be less than, the viewing angle of the reference instrument. FIG. 6 shows a typical design to minimize viewing angle differences. A well calibrated sensor can also be used in a display device such as a television and can be used for one or more of: ambient light detection, an aid to improve visible comfort, or display calibration for accurate color. The calibration method that enables the high accuracy color measurement capability of the sensor involves two distinct calibration components: Linearization-Gain (LG) and Color Matrix determination (CMD).

Mitigation of display drift can be addressed in several different methodologies with a goal of maintaining a given average signal level presented to the display. Maintaining a given average signal presented to the display can be achieved by selecting varying signals whose magnitude differences tend to average to a moderate display value. A three-dimensional collection of RGB color data for a 17×17×17 grid contains roughly 5000 luminances. These data sets can be “sifted” to build a sifted-pseudo-randomized (SPR) collection of color patches whose differences tend toward a given average. When this approach is used in conjunction with settling time constraints considerable improvement in color measurement stability can be achieved and display calibration can be improved.

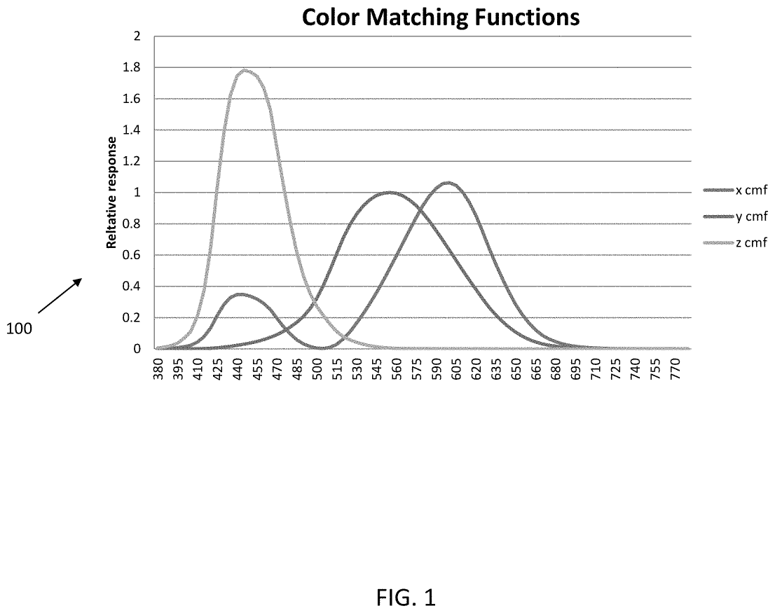

FIG. 1 depicts a plot 100 of the CIE 1931 color matching functions in accordance with an exemplary embodiment. A measurement device that can be calibrated such that the response functions are a linear combination of the CMFs is said to meet the Luther Condition. The plot 100 shows the CIE color matching response curves. The response curves can extend beyond 700 nm, and in some instance can extend up to or beyond 780 nm.

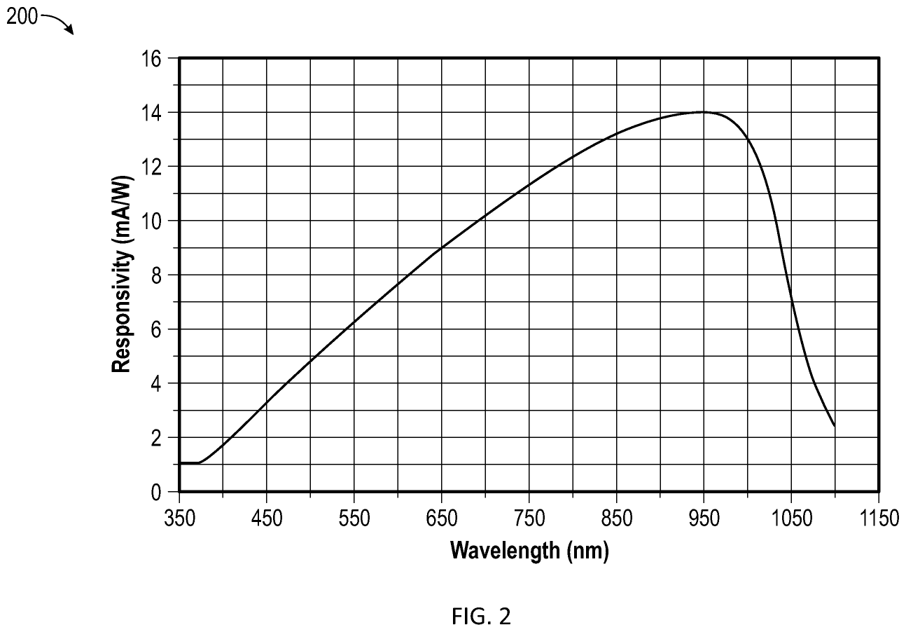

FIG. 2 depicts a plot 200 of silicon photodiode responsivity in accordance with an exemplary embodiment. The plot 200 shows the responsivity of the silicon sensor extends well beyond the 700 nm region with high sensitivity in the near IR region of the spectrum.

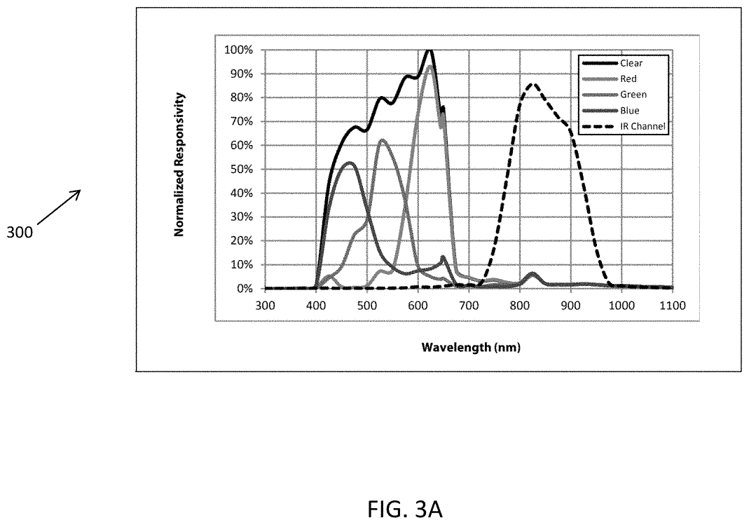

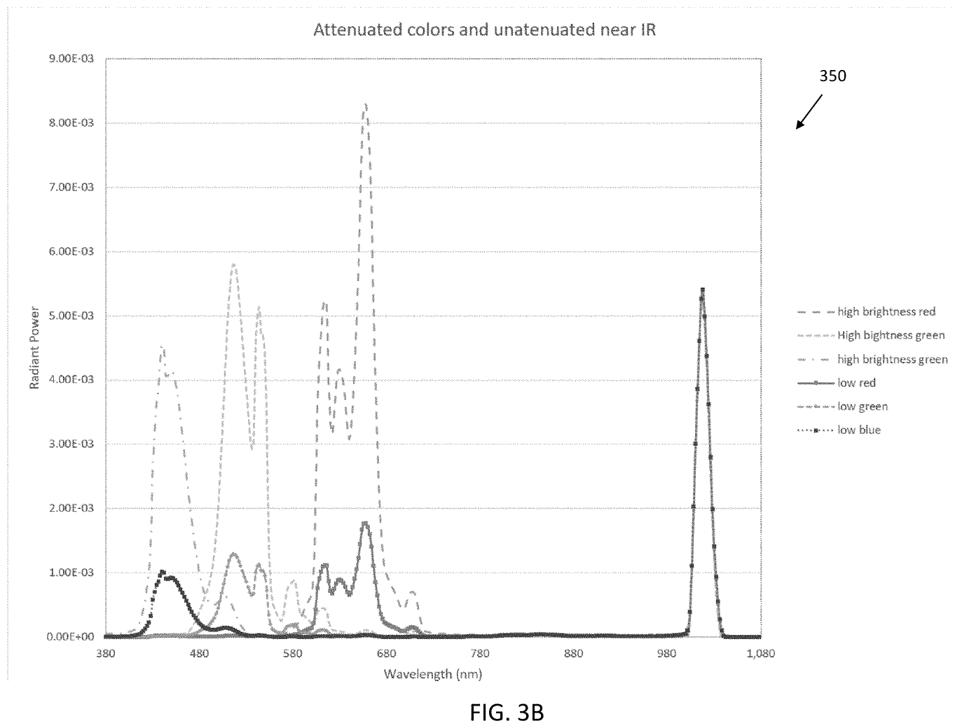

FIG. 3A depicts responsivity characteristics of a Red Green Blue (RGB) and IR filter set according to an exemplary embodiment. The plot 300 shows that the blue filter response is significant in the Green and Red regions of the spectrum and that there is some transmission in the Near IR as well. The goal of a color calibration process is to achieve an optimal match to the color matching function response. The filter response shown in FIG. 3A is indicative of the problem.

FIG. 3B is a graph 350 that illustrates the output of a wide gamut LCD display utilizing a CCFL (Cold Cathode Fluorescent Lamp) backlight. The graph 350 depicts the spectral output of the LCD display at full scale and at half scale. The LCD attenuates the color spectrum but the near IR component remains constant with changes of LCD output. The near IR component is an artifact of the back illumination of from the CCFL. The near IR component can be used to obtain very accurate measure of change in illumination from the backlight itself and when included in the calibration process for the matrix, it can be used to effectively correct for drift in the illumination during data capture. This data can be included in the calculation of the calibration matrix.

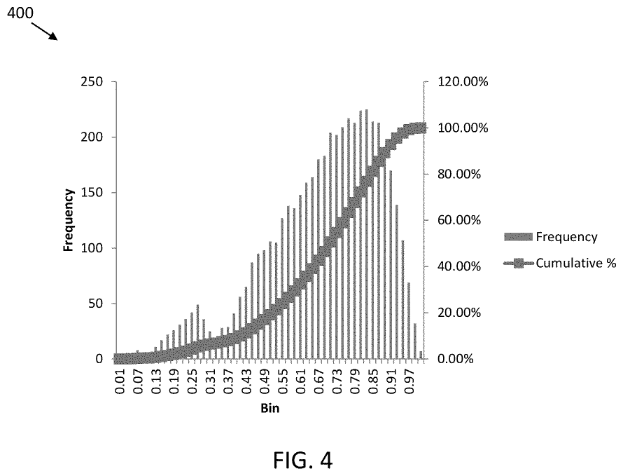

FIG. 4 is a graph 400 a of histogram and cumulative histogram of the luminance of an example 17×17×17 sample data set measurement. Examination of the data indicates that the median normalized luminance value (Y axis=0.5) is approximately 0.7. This value can represent the operational difference used in a sifted-pseudo-random selection process in accordance with embodiments of the present disclosure.

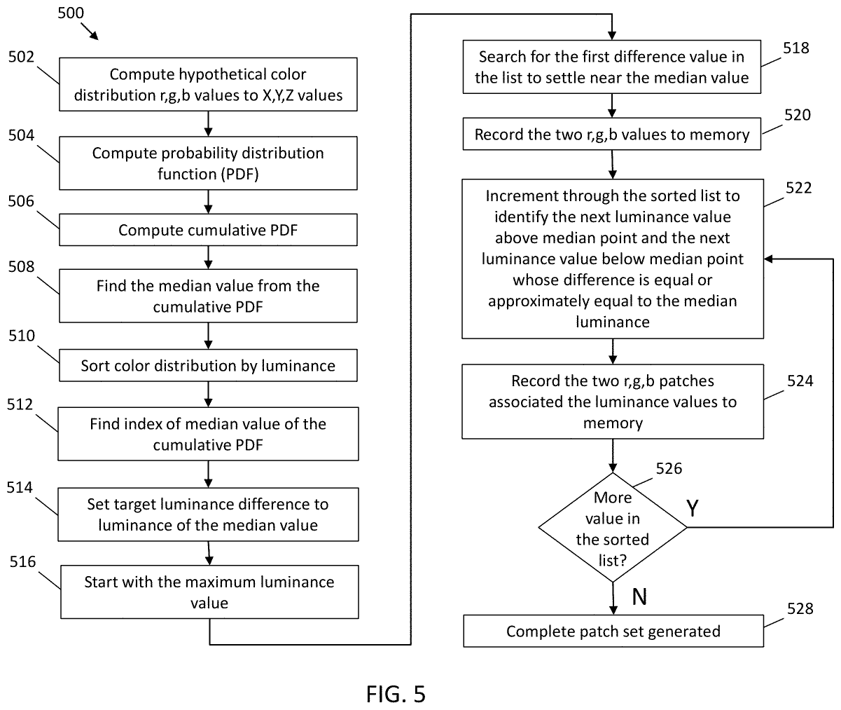

FIG. 5 is a flowchart illustrating a process for generating a median sifted patch set for constant display differences. At step 502, a processor computes a hypothetical color distribution and converts the r,g,b values to X,Y,Z tristimulus values. At step 504, the process computes a probability distribution function (PDF) for the hypothetical color distribution, and at step 506, a cumulative PDF is computed by the processor. At step 508, the processor determines the median value from the cumulative PDF, and at step 510, the values of the color distribution are sorted by their luminance values. At step 512, the processor determine an index of the median value of the cumulative PDF and a target luminance difference is set by the processor at step 514 to be the luminance of the median value. The processor can begin generating one or more patch sets to be used as luminance patterns and one or more patch sets to be used as color patterns for calibration of a display described herein by incrementing through the sorted list in a manner that maintains the target luminance difference. At step 516, a maximum luminance value is selected from the sorted color distribution by the processor to being the patch set generation and the r,g,b values associated with the maximum luminance value are determined. At step 518, the processor search for a first difference value in the sorted color distribution to settle near the median value and the r,g,b values associated with the first difference value are determined. At step 520, the two sets of r,g,b values from steps 516 and 518 are stored in memory. At step 522, the processor increment through the sorted list to identify the next luminance value above median point and the next luminance value below median point whose difference is equal or approximately equal to the median luminance. At step 524, the two sets of r,g,b values associated with the next luminance value above median point and the next luminance value below median point are store in memory.

At step 526, a determination of whether there are more luminance values in the sorted list of the color distribution. If so, the process 500 returns to step 522. Otherwise, the process 500 is complete and the complete patch set is generated.

In situations where the physical backlight drifts as a function of power on time, the SPR method of mitigation may not perform well. Displays found in laptop computers often utilize a “white” led as the principal light element behind the LCD panel. To better understand the nature of drift in this situation the nature of the LED is examined. As shown in graph 600 of FIG. 6, the relative luminance flux (y-axis) of a white light LED tends to increase generally linearly as a function of the forward current (x-axis) even when the white light LED enters saturation. This forward current can be function of different parameters surrounding the operation of the white LED, such as input voltage and operating temperature. Thus, the forward current may change over time despite a desire to maintenance a stable forward current. As a result, the relative luminance flux of the white light LED will also vary over time, which can cause calibration errors during the display calibration.

In general, LED's are powered by a voltage source where the characteristics, such as stability, of the voltage source can affect the output voltage of the voltage source. FIG. 7 shows a graph 700 a typical forward current (y-axis) as a function of a forward voltage (x-axis). As shown in FIG. 7 there is an exponential change in current with respect to voltage, hence, small variability in voltage of the voltage source can lead to a large fluctuation in the forward current and subsequent luminous flux output.

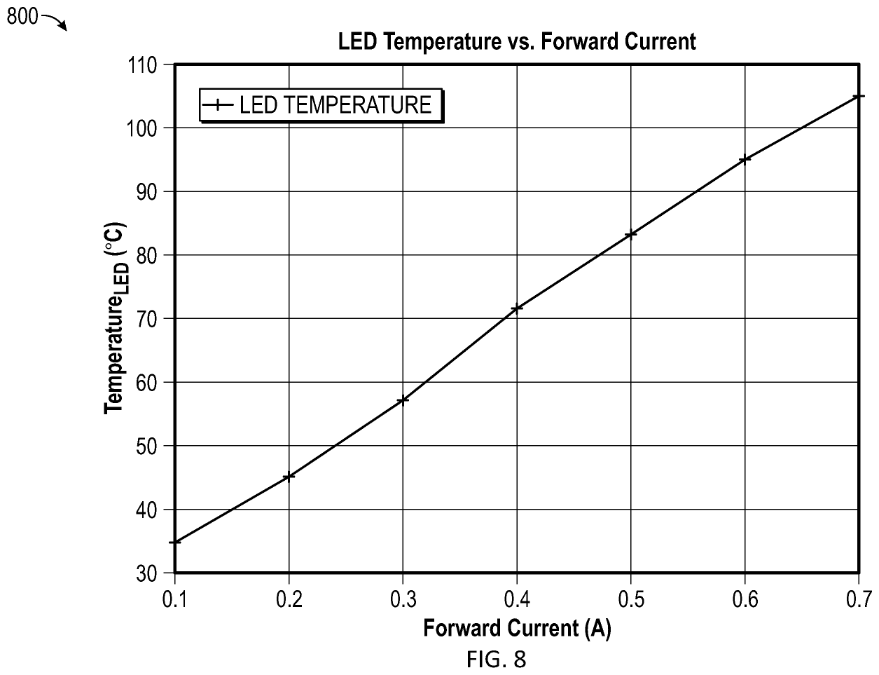

FIG. 8 shows a graph 800 illustrating a change in the operating temperature (y-axis) as a function of a change in the forward current (x-axis) for a typical LED. As shown in FIG. 8, the operating temperature generally increases linearly as the forward current increases.

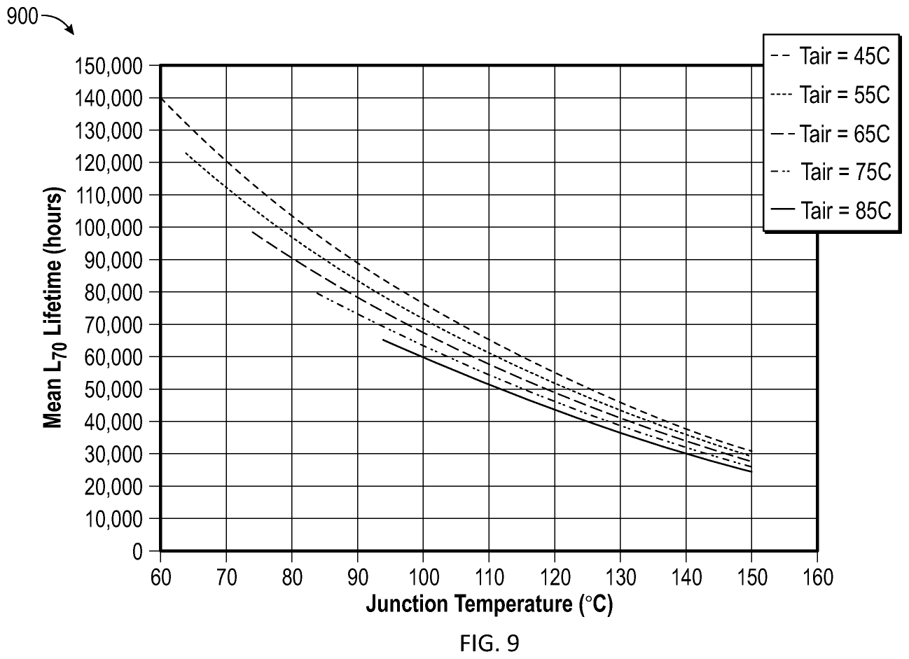

FIG. 9 shows a graph 900 illustrating example changes in luminance over a lifetime of a typical LED as a function of the junction temperature of the LED. The graph 900 depicts the ambient temperature effect on both life time and maximum achievable luminance of the LED.

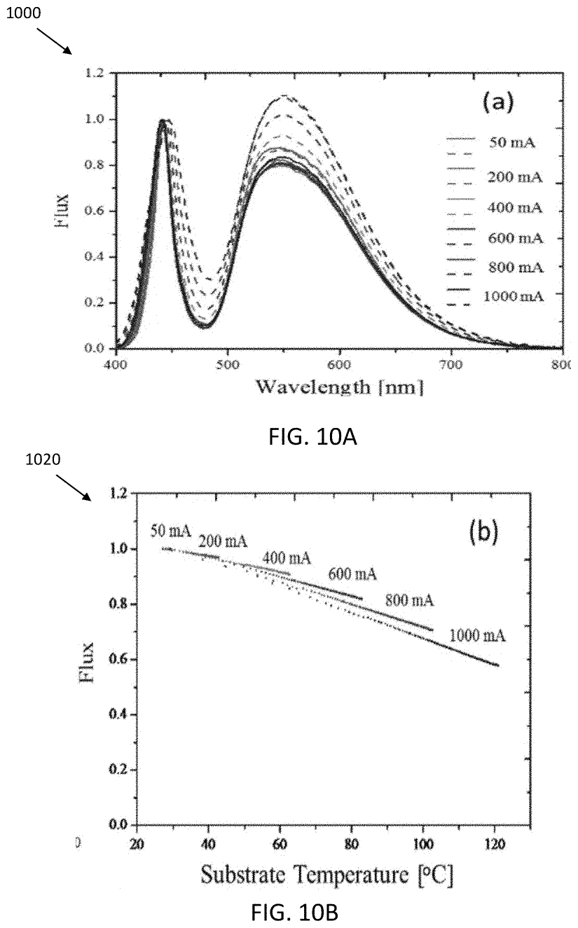

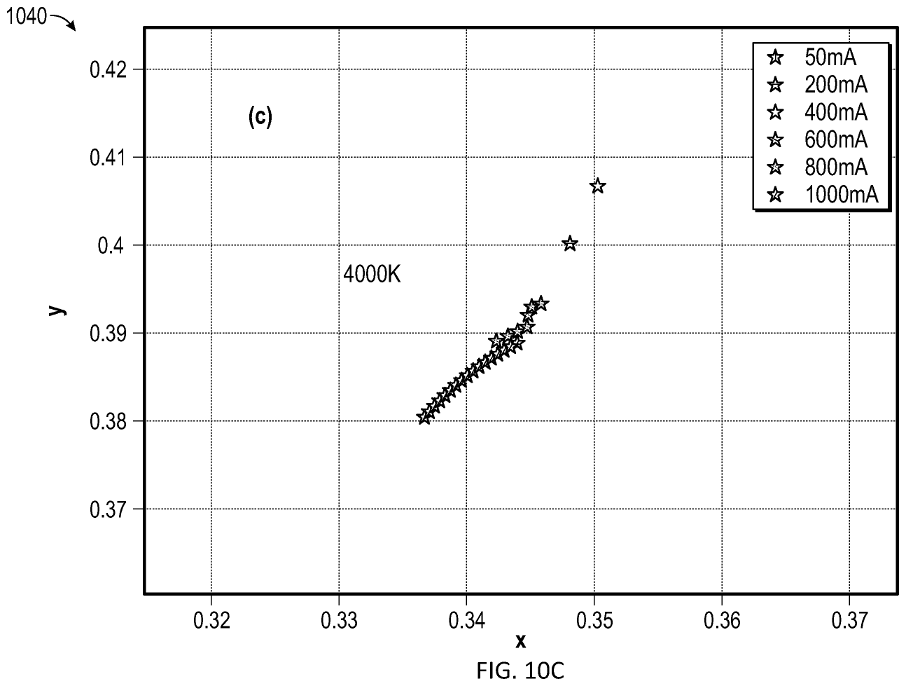

FIG. 10A shows a graph 1000 that illustrates a luminance flux as a function of wavelength for different forward currents for typical LEDs. FIG. 10B shows a graph that illustrates a luminance flux as a function of substrate temperature for different forward currents for typical LEDs. FIG. 10C illustrates a trend in color temperature of typical LEDS for different the forward currents. In general, as substrate temperature increases the colorimetry shifts towards the blue portion of the visible gamut. As shown in FIGS. 9 and 10A-C, the colorimetry can be characterized as a function of both ambient temperature and initial current setting as specified by a relative initial panel luminance setting.

As illustrate via FIGS. 6-10A-C colorimetric drift due to both ambient temperature and junction temperature is generally well behaved and can be characterized with linear regression analysis. Collection of both colorimetry and ambient temperature can be achieved by adding a thermal sensor to the calibration colorimeter embodiment. This will allow simultaneous capture of colorimetry and ambient temperature. The addition of a thermal sensor can be achieved in several ways. As one example, a temperature sensor can be molded into an enclosure near an influx aperture of a color sensor. One challenge with this approach can be the need to connect the temperature sensor to a circuit board during assembly. This challenge can be mitigated through use of a thermally conductive element that conducts the ambient temperature signature to a circuit board element. This can be part of the optical housing for the color sensor. The conductive element can be made of a metal such as copper or a conductive plastic material. In this case, the optical aperture assembly would be used to conduct the temperature directly to the part for monitoring.

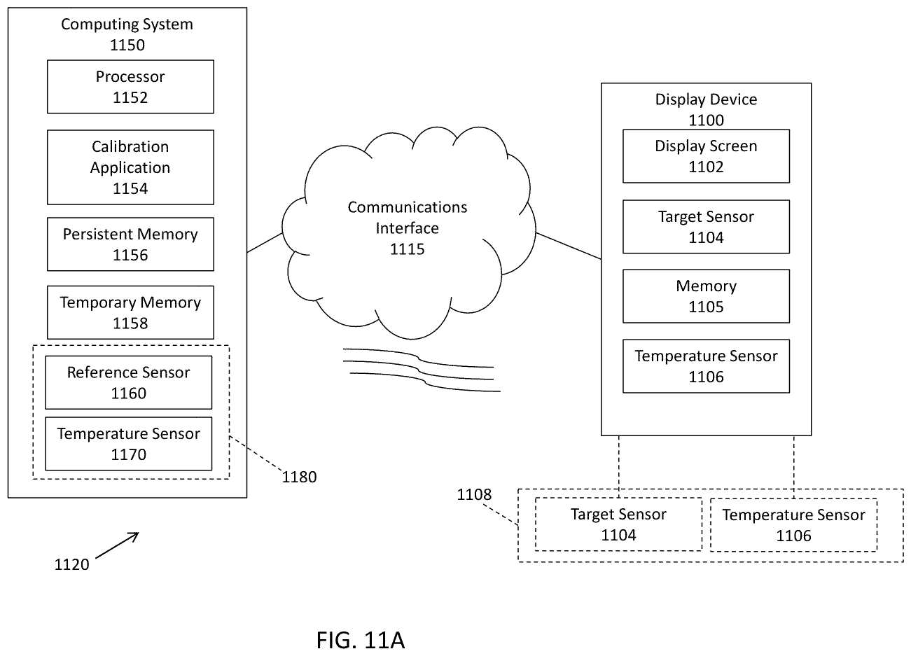

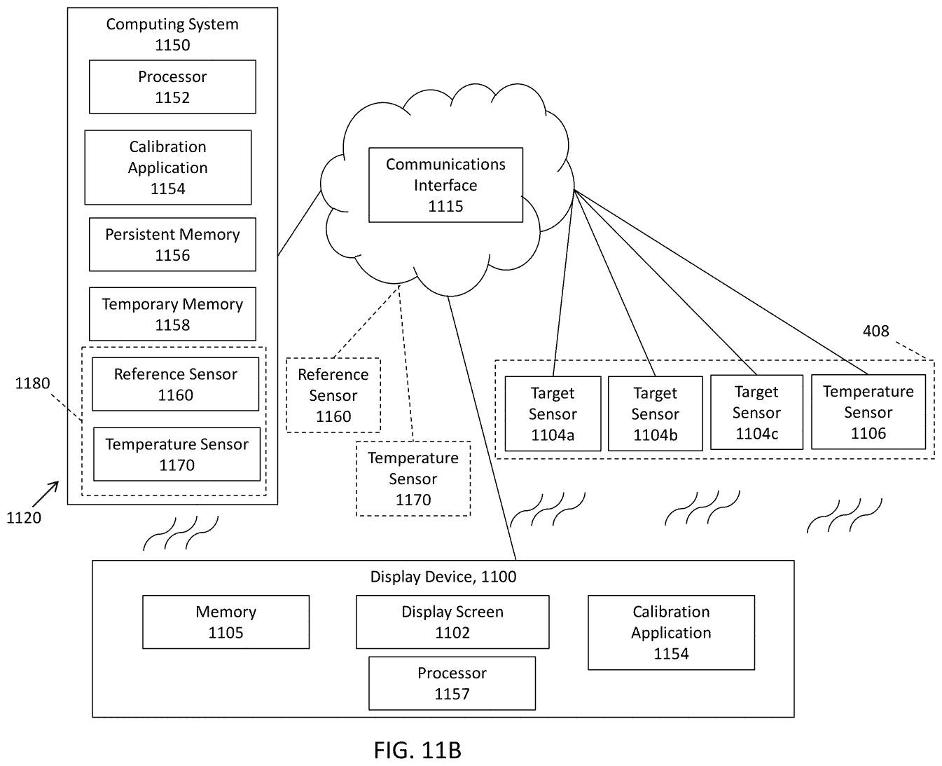

FIGS. 11A-11B illustrate a block diagram of a color calibration system 1120 in accordance to an exemplary embodiment. With reference to FIG. 11A, in one embodiment, the color calibration system 1120 can include one or more computing systems 1150, and one or more display devices 1100, communicating over a communications interface 1115. The display device 1100 can include a display screen 1102, a memory 1105, a target sensor 1104, and a temperature sensor 1106. The target sensor 1104 and/or temperature sensor 1106 can be embedded or attached to the display device 1100. The computing system 1100 can include a processor 1152, calibration application 1154, persistent memory 1156, temporary memory 1158 (e.g., RAM), a reference sensor 1160, and a temperature sensor 1170. In example embodiments, the target sensor 1104 and the temperature sensor 1106 can be separate components or can be integrated together into a single package and/or integrated on a single substrate 1108 (e.g., the sensors 1104 and 1106 can fabricated together using one or more semiconductor fabrication processes. In example embodiments, the reference sensor 1160 and the temperature sensor 1170 can be separate components or can be integrated together into a single package and/or integrated on a single substrate 1180 (e.g., the sensors 1160 and 1170 can fabricated together using one or more semiconductor fabrication processes. The computing system 1100 can execute one or more instances of the calibration application 1154 to implement the color calibration system 1120. The calibration application 1154 can be an executable application residing on the computing system 1150. The computing system 1150 can be embodied as one or more computers or servers. In an example embodiment, the temperature sensor 1106 can be integrated with the target sensor 1106 and/or the temperature sensor 1170 can integrated with the reference sensor 1170.

In an example embodiment, one or more portions of the communications interface 1115 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, Near Field Communication (NFC) interfaces such as Bluetooth @, or any other type of network, or a combination of two or more such networks. In an example embodiment, the communications interface 1115 can be a universal serial bus (USB) interface, a coaxial cable interface, an Ethernet cable interface, or any suitable connector interface.

The computing system 1150 includes one or more computers or processors configured to communicate with the display device 1100 via the communications interface 1115. The computing system 1150 hosts one or more applications configured to interact with one or more components of the color calibration system 1120. The persistent and temporary memory 1156, 1158 can be located at one or more geographically distributed locations from the first computing system 1150. Alternatively, the persistent and temporary memory 1156, 1158 can be included within the computing system 1150.

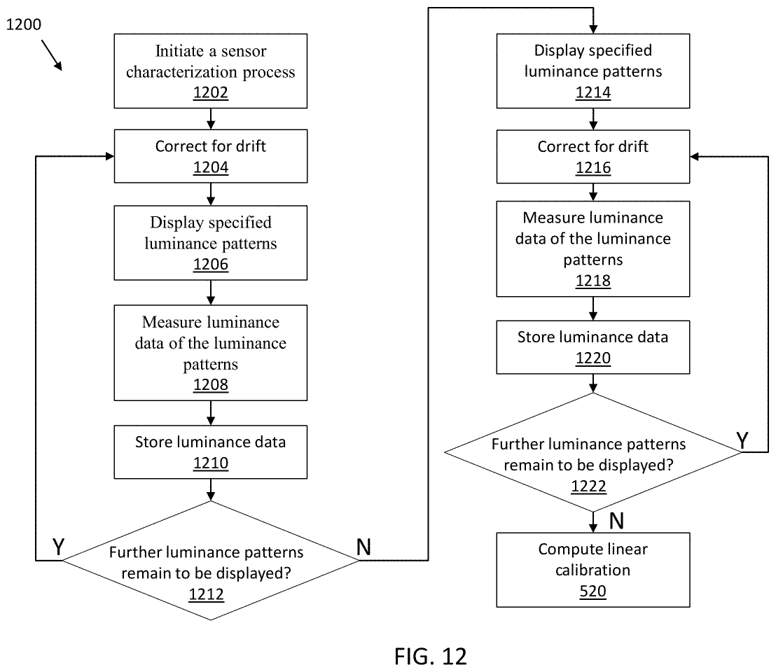

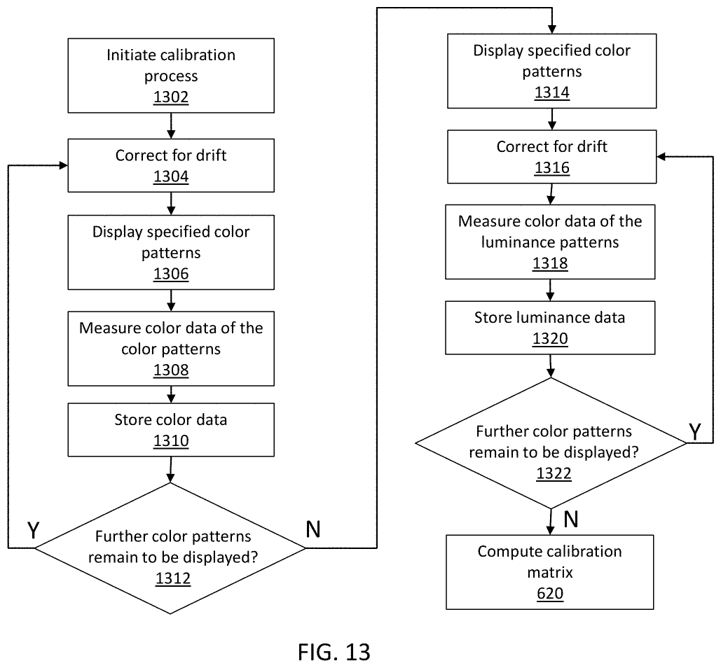

In one embodiment, a calibrated reference sensor 1160 and/or temperature sensor can be attached to or residing in the computing system 1150. The calibrated reference sensor 1160 can detect and capture luminance and/or color data from the display screen 1102 and the temperature sensor 1170 can measure temperature data of the environment surrounding the temperature sensor 1170. The captured data from the reference sensor 1160 and/or the temperature sensor 1170 can be stored in temporary memory 1158. The target sensor 1104 can detect and capture luminance and/or color data from the display screen 1102 and the temperature sensor 1106 can measure temperature data of the environment surrounding the temperature sensor 1106. The display device 1100 can transmit the captured data from the target sensor 1104 and/or the temperature sensor 1106 to the computing system 1150, via the communications interface 1115. The captured data from the target sensor 1104 and/or the temperature sensor 1106 can be stored in temporary memory 1158. The calibration application 1154 can execute the linearization process and calculate the calibration matrix, as described herein, for example, with respect to FIGS. 12 and 13. The computing system 1150 can transmit the calculated calibration matrix to the display device 1100, via the communications interface 1115. The display device 1100 can store the calibration matrix in the memory 1105. The display device 1100 can calibrate the target sensor 1104 using the calibration matrix stored in the memory 1105.

With reference to FIG. 11B, one or more target sensors 1104a-c and/or temperature sensors 1106 can be disposed externally to the display device 1100. An instance of the calibration application 1154 can reside on the display device 1100. The display device 1100 can also include a processor 1157. The calibrated reference sensor 1160 can detect and capture data from the display screen 1102 and the temperature sensor 1106 can measure temperature data of the environment surrounding the temperature sensor 1106. The reference sensor 1160 can be a stand-alone device that is in communication with the processor 1157 of the display device 1100. The captured data can be stored in temporary memory 1158. The captured data can be transmitted to the display device 1100. The display device 1100 can store the captured data in the memory 1105.

The target sensors 1104a-c can detect and capture data from the display screen 1102. The target sensors 1104a-c can transmit the captured data to the display device 1100, via the communications interface 1115. The calibration application 1154 residing on the display device can execute the linearization process and calculate the calibration matrix as described herein, for example, with respect to FIGS. 12 and 13. The calibration matrix can be stored in the memory 1105. The calibration application 1154 residing on the display device 1100 can calibrate the target sensors 1104a-c using the calibration matrix stored in the persistent memory 1156.

With reference to both FIGS. 11A-11B, the reference sensor 1160 and target sensor 1104 (or 1104a-c) can be luminance and/or color sensors. Color sensors can detect and capture color measurement, determination, and distinguish between colors emitted from a surface such as a display device 1100. Luminance sensors can detect and capture light intensity measurement, determination, and distinguish between different intensities of light from a surface such as a display device 1100. In this regard, the reference sensor 1160 and target sensor 1104 (or 1104a-c) can detect and capture luminance and/or color measurements, determinations, and distinguish between colors displayed on the display screen 1102 of the display device 1100.

The target sensor 1104 (or 1104a-c) and/or the reference sensor 1160 can include channels or filters that are sensitive or response to specific colors or wavelengths as described herein. As an example, the target sensor 1104 (or 1104a-c) and/or the reference sensor 1160 can include channels responsive to wavelength associated with the color red, channels responsive to the wavelengths associated with the color green, and channels responsive to the wavelengths associated with the color blue (see, e.g., FIGS. 3A-B). The target sensor 1104 (or 1104a-c) and/or the reference sensor 1160 can also include channels responsive to wavelength associated with a wideband channel that include wavelengths associated visible light corresponding to white light or multiple colors and channels responsive to the wavelengths associated with near infrared (IR) (see, e.g., FIGS. 3A-B). The target sensor 1104 (or 1104a-c) and/or the reference sensor 1160 can have five separate channels of sensitivity—Red, Green, Blue, Wideband, and near IR.

As described above, the reference sensor 1160 can already be calibrated, while the target sensor 1104 (or 1104a-c) can be calibrated based on the calculated calibration matrix. As a non-limiting example, the reference 1102 and target sensor 1104 (or 1104a-c) can be embodied as AMS TCS 3430 and AS7261. The display device 1100 can be one or more of a: television, computer screen, mobile device, or any other type of display device 1100. The display screen 1102 can be a LCD or LED display.

FIG. 12 illustrates a linearization process 1200 for a sensor in accordance with an exemplary embodiment. In operation 1202, the calibration application (i.e., calibration application 1154 as shown in FIGS. 11A-B) can initiate a sensor characterization process. The drift of the display, e.g., due to drift in the backlight of the display from changes in operating temperature, forward voltage, and/or forward current associated with the backlight, can be modeled using regression by measuring the drift over a specified period of time relative a temperature of the display. The model of the drift can be stored memory, and in step 1204, the drift in the color output by the display can be corrected using the model of the drift. For example, the display can be operated to display a fixed color (or color pattern) and the operating temperature (e.g., measured by the temperature sensor 406 and/or 470) and color (measured by the target sensor 404 and/or reference sensor 460) displayed by the display can be simultaneously measured over a specified period of time.

In operation 1206, the display screen (i.e., display screen 1102 as shown in FIGS. 11A-B) can display specified luminance patterns that are formed, for example, from the patch sets generated according to the process described herein with reference to FIG. 5. In operation 1208, a calibrated reference sensor (e.g., reference sensor 1160 as shown in FIGS. 11A-B) can measure luminance data of the luminance patterns displayed on the display screen for each channel—red, green, blue, near-IR, and wideband. In operation 1210, the captured luminance data for each channel can be stored in a temporary memory (e.g., temporary memory 1158 as shown in FIGS. 11A-B). In operation 1212, the calibration application can determine whether further luminance patterns of the specified luminance patterns remain to be displayed. In the event, further luminance patterns remain to be displayed, the calibration application can execute operations 1204-1210 of the linearization process 1200 for each of the luminance patterns of the specified luminance patterns. The luminance captured by reference sensor for each of the luminance patterns can be stored in the temporary memory. The number of specified luminance patterns can vary, however, as a non-limiting example, the number of luminance patterns can be 15-17.

In operation 1214, the same specified luminance patterns are displayed on the display screen. In step 1316, the drift in the color output by the display can be corrected using the model of the drift. In operation 1218, a target sensor (e.g., target sensor 1104, 1104a-c as shown in FIGS. 11A-B) can measure luminance data of the luminance patterns displayed on the display screen for each channel—red, green, blue, near-IR, and wideband. In operation 1220, the captured luminance data for each channel can be stored in the temporary memory. In operation 1222, the calibration application can determine whether further luminance patterns of the specified luminance patterns remain to be displayed. In the event, further luminance patterns remain to be displayed, the calibration application can execute operations 1214-1220 of the linearization process 1200 for each of the luminance patterns of the specified luminance patterns. The luminance captured by target sensor for each of the luminance patterns can be stored in the temporary memory.

In operation 1224, the calibration application can compute the linear calibration using the luminance captured by the reference sensor and the luminance captured by the target sensor. The computing of linear calibration can include generating a linearization look up table or a numerical mapping based upon regression analysis. The use of regression analysis allows for calibration of absolute luminance as well as linearization.

The luminance properties of the display and the color properties of the display (CMD) obtained from both data collection processes (i.e., data captured by the reference and target sensor) can be combined and stored in a single data storage device. While calibrating a display device, both sets of data can be used to determine optimum exposure and linearity correction and then calculate the color correction using the data that has been corrected for linearity.

When calibrating a display device of a monitor or television, the measurements can be made essentially simultaneously (e.g., steps 1204-1212 and 1214-1222 can be performed in parallel or concurrently with each other). It can be appreciated, that when calibrating a display device of a mobile device (i.e., a laptop) it can be necessary to perform the embedded sensor measurements with the laptop cover closed. The reference measurements can require that the laptop cover be in an open position, and the display exposed to the reference sensor. The laptop display may then be in a closed position, and the embedded sensor data can be captured.

Once the embedded sensor has been characterized for linearity and gain, as described with respect to FIG. 12, the calibration process, as described with respect to FIG. 12 can be executed by the calibration application.

FIG. 13 illustrates a calibration process 1300 of the color calibration system in accordance to an exemplary embodiment. In operation 1302, the calibration application (i.e., calibration application 1154 as shown in FIGS. 11A-B) can initiate the calibration process 1300. The drift of the display, e.g., due to drift in the backlight of the display from changes in operating temperature, forward voltage, and/or forward current associated with the backlight, can be modeled using regression by measuring the drift over a specified period of time relative a temperature of the display. The model of the drift can be stored memory, and in step 1304, the drift in the color output by the display can be corrected using the model of the drift. For example, the display can be operated to display a fixed color (or color pattern) and the operating temperature (e.g., measured by the temperature sensor 406 and/or 470) and color (measured by the target sensor 404 and/or reference sensor 460) displayed by the display can be simultaneously measured over a specified period of time. In operation 1306, the display screen (i.e., display screen 1102 as shown in FIGS. 11A-B) can display specified color patterns that are formed, for example, from the patch sets generated according to an embodiment of the process described herein with reference to FIG. 5. In operation 1308, a calibrated reference sensor (i.e., reference sensor 1160 as shown in FIGS. 11A-B) can measure color data of the color patterns displayed on the display screen for each channel—red, green, blue, near-IR, and wideband. As an example, White, Red, Green, and Blue patterns, each at 5 luminance levels for a total of 20 reads, can be captured. In operation 1310, the captured color data for each channel can be stored in a temporary memory (i.e., temporary memory 1158 as shown in FIG. 11). In operation 1312, the calibration application can determine whether further color patterns of the specified color patterns remain to be displayed. In the event, further color patterns remain to be displayed, the calibration application can execute operations 1304-1310 of the calibration process 1300 for each of the color patterns of the specified color patterns. The color captured by reference sensor for each of the color patterns can be stored in the temporary memory. The number of specified color patterns can vary, however, as a non-limiting example, the number of color patterns can be 15-17.

In operation 1314, the same specified color patterns are displayed on the display screen. In step 1316, the drift in the output by the display can be corrected using the model of the drift. In operation 1318, a target sensor (i.e., target sensor 1104, 1104a-c as shown in FIGS. 11A-B) can measure color data of the color patterns displayed on the display screen for each channel—red, green, blue, near-IR, and wideband. As an example, White, Red, Green, and Blue patterns, each at 5 luminance levels for a total of 20 reads, can be captured. In operation 1320, the captured color data for each channel can be stored in the temporary memory. In operation 1322, the calibration application can determine whether further color patterns of the specified color patterns remain to be displayed. In the event, further color patterns remain to be displayed, the calibration application can execute operations 1314-1320 of the calibration process 1300 for each of the color patterns of the specified color patterns. The color captured by target sensor for each of the color patterns can be stored in the temporary memory.

In operation 1324, the calibration application can compute the calibration matrix using the color data captured by the reference sensor, the color data captured by the target sensor, and the linear calibration output by the process 1200 described with reference to FIG. 12, and as further described herein. The calibration matrix can be stored in persistent memory (i.e., persistent memory 1156 as shown in FIG. 11). The calibration matrix can be used to calibrate the target sensor.

When calibrating a display device of a monitor or television, the measurements can be made essentially simultaneously (e.g., steps 1304-1312 and 1314-1322 can be performed in parallel or concurrently with each other). It can be appreciated, that when calibrating a display device of a mobile device (i.e., a laptop) it can be necessary to perform the embedded sensor measurements with the laptop cover closed. The reference measurements can require that the laptop cover be in an open position, and the display exposed to the reference sensor. The laptop display may then be in a closed position, and the embedded sensor data can be captured.

In one embodiment, the raw sensor values used for the target data set are collected as a vector in the form as follows:

˜v=[X,Y,Z,I],

where X, Y, and Z represent tristimulus values and I represents the near-IR channel. A fifth parameter R can be used for scaling and can be attached to all raw data, which reads as follows:

R=(X²+Y²+Z²)^{1/2}

˜v⇒[X,Y,Z,I,R]

The pattern set (as described with respect to operation 1308 and 1318) includes 5 luminance values each for White, Red, Green, and Blue for a total of 20 patterns to be read by both the target and reference device. In one embodiment, the total 20 reads can be embodied as follows:

{w1,w2,w3,w4,w5,r1,r2,r3,r4,r5,g1,g2,g3,g4,g5,b1,b2,b3,b4,b5}

The 20 total reads can be accumulated as matrix T, as follows:

$$T = [ \begin{matrix}{X}_{ω1} & {Y}_{ω1} & {Z}_{ω1} & {I}_{ω1} & {R}_{ω1} \\ {X}_{ω2} & {Y}_{ω2} & {Z}_{ω2} & {I}_{ω2} & {R}_{ω2} \\ {X}_{ω3} & & … & & {R}_{ω3} \\ {X}_{ω4} & & … & & {R}_{ω4} \\ {X}_{ω5} & & … & & {R}_{ω5} \\ {X}_{r 1} & & … & & ⋮ \\ ⋮ & & ⋱ & & ⋮ \\ {X}_{ℊ1} & & … & & ⋮ \\ ⋮ & & ⋱ & & ⋮ \\ {X}_{b 1} & & … & & ⋮ \\ ⋮ & & ⋱ & & ⋮ \\ {X}_{b 5} & {Y}_{b 5} & {Z}_{b 5} & {I}_{b 5} & {R}_{b 5}\end{matrix} ]$$

Reference data can be collected using the identical pattern set and stored as the matrix R:

$$R = [ \begin{matrix}{X}_{ω1} & {Y}_{ω2} & {Z}_{ω1} \\ {X}_{ω2} & {Y}_{ω2} & {Z}_{ω2} \\ {X}_{ω3} & … & {Z}_{ω3} \\ {X}_{ω4} & … & {Z}_{ω4} \\ {X}_{ω5} & … & {Z}_{ω5} \\ {X}_{r 1} & … & ⋮ \\ ⋮ & ⋱ & ⋮ \\ {X}_{ℊ1} & … & ⋮ \\ ⋮ & ⋱ & ⋮ \\ {X}_{b1} & … & ⋮ \\ ⋮ & ⋱ & ⋮ \\ {X}_{b5} & {Y}_{b5} & {Z}_{b5}\end{matrix} ]$$

A gross calibration matrix (C) can be calculated to convert raw sensor data into usable X,Y,Z Tri-Chromatic data. The calibration matrix maps raw sensor data to scaled tristimulus values in units of (cd/m²).

C=(R^{Transpose}*T)*(T^{Transpose}*T)⁻¹

Where the final calibration matrix can be embodied as follows:

$$C = [ \begin{matrix}{X}_{CX} & {Y}_{CX} & {Z}_{CX} & {I}_{CX} & {R}_{CX} \\ {X}_{CY} & {Y}_{CY} & {Z}_{CY} & {I}_{CY} & {R}_{CY} \\ {X}_{CZ} & {Y}_{CZ} & {Z}_{CZ} & {I}_{CZ} & {R}_{CZ}\end{matrix} ] ,$$

The initial calibration undergoes a second adjustment based on a calibration matrix as described in “Four-Color Matrix Method for Correction of Tristimulus Colorimeters Part 1” and “Four-Color Matrix Method for Correction of Tristimulus Colorimeters Part 2” to Yoshihiro Ohno and Jonathan E. Hardis, which is fully incorporated by reference herein. A single color vector from the sensor initial raw readings (i.e., target data set) can be constructed using the readings for White, Red, Green, and Blue. Each of these vectors can be passed through the final calibration matrix, C, to generate 4 unit adjusted color vectors as follows:

$${ϑ}_{UnitColor} = C * {ϑ}_{RawColor} \\ [ \begin{matrix}{X}_{CX} & {Y}_{CX} & {Z}_{CX} & {I}_{CX} & {R}_{CX} \\ {X}_{CY} & {Y}_{CY} & {Z}_{CY} & {I}_{CY} & {R}_{CY} \\ {X}_{CZ} & {Y}_{CZ} & {Z}_{CZ} & {I}_{CZ} & {R}_{CZ}\end{matrix} ] [ \begin{matrix}{X}_{raw} \\ {Y}_{raw} \\ {Z}_{raw} \\ {I}_{raw} \\ {R}_{raw}\end{matrix} ] = [ \begin{matrix}{X}_{c} \\ {Y}_{c} \\ {Z}_{c}\end{matrix} ]$$

Following this pattern, 5 raw element vectors for White, Red, Green, and Blue can be passed through the initial unit calibration matrix, thus creating four new vectors that contain unit corrected XYZ tristimulus values.

$$[ \begin{matrix}{X}_{reference , 255 white} \\ {Y}_{reference , 255 white} \\ {Z}_{reference , 255 white}\end{matrix} ] , [ \begin{matrix}{X}_{reference , 255 red} \\ {Y}_{reference , 255 red} \\ {Z}_{reference , 255 red}\end{matrix} ] , [ \begin{matrix}{X}_{reference , 255 green} \\ {Y}_{reference , 255 green} \\ {Z}_{reference , 255 green}\end{matrix} ] , [ \begin{matrix}{X}_{reference , 255 blue} \\ {Y}_{reference , 255 blue} \\ {Z}_{reference , 255 blue}\end{matrix} ]$$

These four unit calibrated color vectors can be used in conjunction with the four reference values of the same patterns to derive a 3×3 calibration matrix, W, that anchors the calibration to a reference white point.

$${W}_{whitepoint} = [ \begin{matrix}{X}_{WX} & {Y}_{WX} & {Z}_{WX} \\ {X}_{WY} & {Y}_{WY} & {Z}_{WY} \\ {X}_{WZ} & {Y}_{WZ} & {Z}_{WZ}\end{matrix} ]$$

The final calibration matrix can be calculated as follows:

M_{Final}=W_{whitepoint}*Cᵤₙᵢₜ

The described system can separate the reference data set from the target data set, used to physically calibrate the sensor. This provides the physical separation of the element containing the sensor to be calibrated from the display that will use the sensor for display calibration purposes. Using this configuration a first-use calibration process that uses the factory stored reference data set and a captured target data set can be used in the numerical process to arrive at the sensor color calibration matrix.

The processes described with respect to FIGS. 12 and 13 can be implemented in several ways. For example, in a factory calibration scenario, with a built-in target sensor in the display device (as shown in FIG. 11A), the process can be completed using a computing system (e.g., computing system 1150 as shown in FIGS. 11A-B) and a reference sensor to collect and store the reference data and a target sensor to collect the device specific data. The computing system can calculate the necessary calibration matrix and then transmit the calibration matrix to the display device.

In event where the target sensor is not tethered or built into the display device, the process can executed by implementing the calibration algorithm physically in the device under test. In this scenario, the device under test may control a reference device or an external computer and reference device can be used to capture the reference data and store said reference data in the device under test. The sensor calibration is then implemented at a later stage, by capturing data from the external sensor and using the previously captured reference data to compute the calibration of the sensor. This method is particularly suited to calibration of external sensors in a Television system.

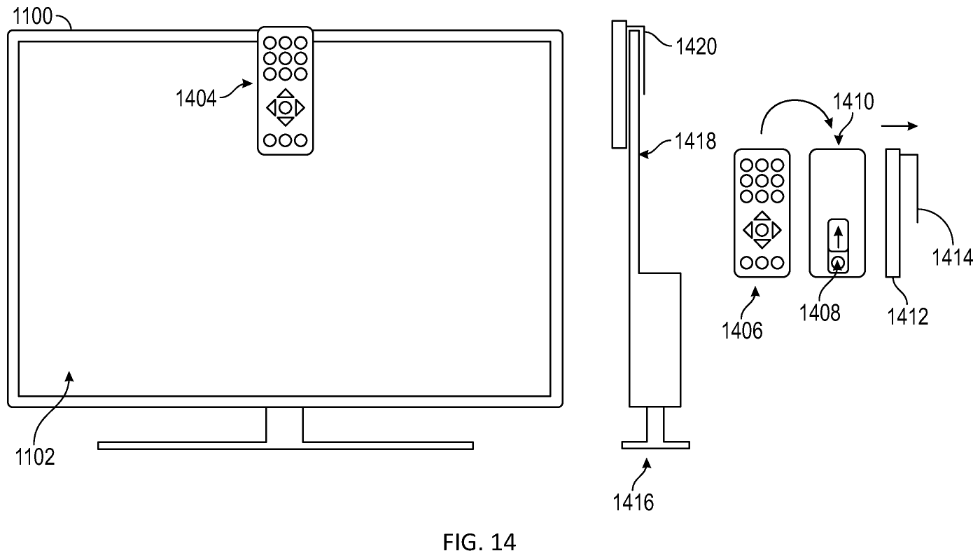

FIGS. 14-17 depict various embodiments of the target sensors and display devices. In each of these embodiments, the target sensor can be calibrated using the process described with respect to FIGS. 12-13. In some embodiments, a target sensor can be calibrated prior to the first use of the display device. This configuration can be known as fixed factory calibration. Alternatively, or in addition to, the target sensor can be calibrated on the first use of the display device. This configuration can be known as “first use” calibration.

FIG. 14 depicts a sensor 1408 built in a remote 1404 in accordance with an exemplary embodiment. In one embodiment, a sensor 1408 can be embedded in a remote control 1404 configured to control the operation of a display device 1100 such as a television. The display device 1100 can include a display screen 1102. The display screen 1102 can be a LCD or LED display.

The remote control 1404 can include a front side 1406 and a backside 1410. The sensor 1408 can be embedded in the backside 1410 of the remote control 1404. The side view 1416 of the sensor 1408 depicts a clip 1414 disposed on the backside 1410 of the sensor 1408. The clip 1414 can include a horizontal portion, extending from the backside 1410 of the remote control 1404 and a vertical portion, extending downward from the horizontal portion. The clip 1414 can couple the remote control 1404 to the display device 1100, such that the front side 1406 of the remote control 1404 faces away from the display screen 1102, the horizontal portion of the clip 1414 extents across the top portion 1420 of the display device 1100, and the vertical portion of the clip 1414 can extend down the backside 1418 of the display device 1100. In this position, the backside 1406 of the remote control 1408 faces the display screen 1102 of the display device 1100, such that the sensor 1408 is interfacing with the display screen 1102 of the display device. The side view 1416 of the display device depicts the remote control 1404 coupled to the display device 1100.

In one embodiment, the display device 1100 can be a television and the display screen 1102 can be characterized in the factory and the reference data set can be stored in non-volatile memory in the display device. Upon first use of the display device 1100, the calibration process, as described with respect to in FIGS. 12-13, can be employed to calibrate the embedded sensor 1408 in the remote control 1404. Bluetooth® communication or other NFC communication can be implemented to coordinate actions between the embedded sensor and the display device 1100. The raw target data captured by the remote control 1404, can be used to calculate the proper correction matrix as described with respect to FIG. 12 and the numerical process to establish the calibration matrix. The calibration matrix can be stored display device's 1100 non-volatile memory. For example, the calibration application (i.e., calibration application 1154 as shown in FIG. 11B) can reside in the display device 1100. The calibration application can use the reference data set and the target data set captured by the reference and target sensors, respectively, and stored in the non-volatile memory (i.e., memory 1105 as shown in FIG. 11B) to calculate the calibration matrix. The calibration matrix can be used to calibrate the sensor 1408.

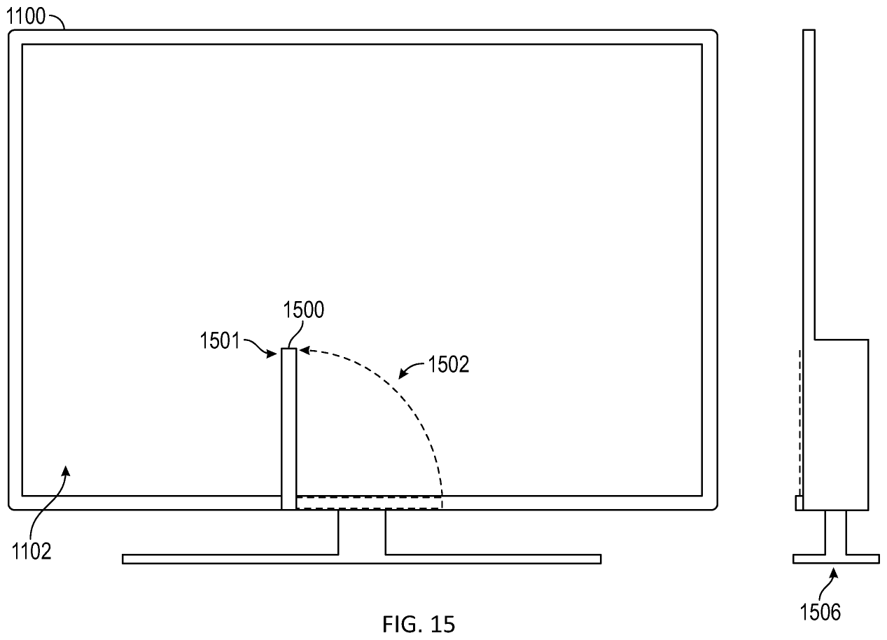

FIG. 15 depicts a sensor 1500 on a rotating mount 1501 in accordance with an exemplary embodiment. In one embodiment, a sensor 1500 can be coupled to the display device 1100 using a rotating mount 1501. In one example, the rotating mount 1501 can be disposed on the bottom of the display screen 1102 of the display device 1100. In an initial position the rotating mount 1501 can extend horizontally along the bottom of the display device 1100. The rotating mount 1501 can circumferentially rotate around a point at which the rotating mount 1501 is coupled to the display device 1100. The rotating mount 1501 can rotate so that the sensor 1500 interfaces with the display screen 1102. The rotating mount 1501 can rotate 180 degrees from its initial position. The rotating mount 1501 can be moved into a position for calibration of the display and moved back down to its initial position for normal viewing.

As described above, in one embodiment, the display device 1100 can be a television. In one embodiment, the calibration can be performed as described with respect to FIGS. 12-13 and the corresponding numerical method to arrive at the calibration matrix, using a fixed factory calibration. The calibration matrix can be stored in the non-volatile memory (i.e., memory 1105 as shown in FIGS. 11A-B). The sensor 1500 (i.e., target sensor) can be calibrated prior to first use of the display device 1100. The side view 1506 of the display device 1100 can depict the placement of the sensor 1500.

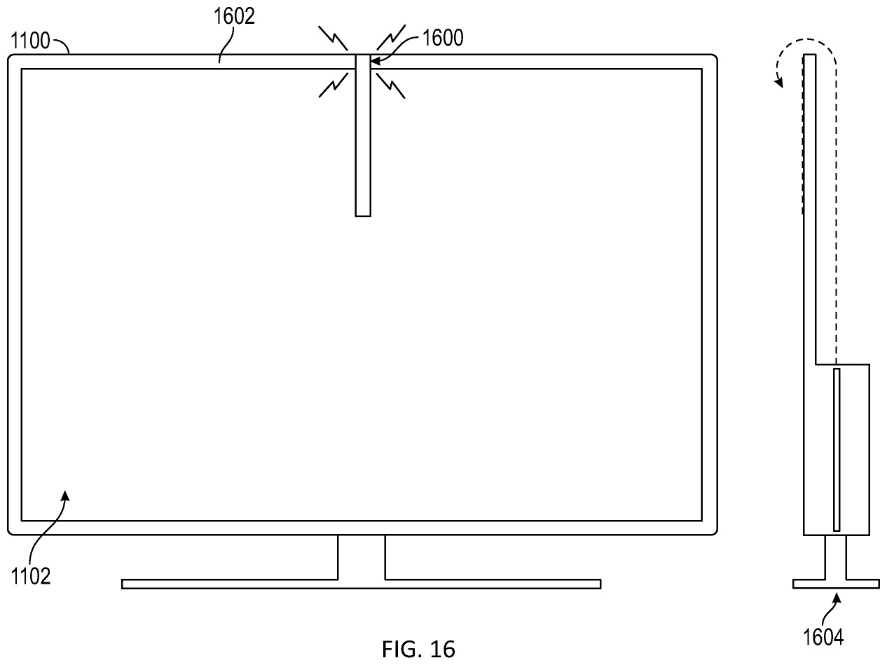

FIG. 16 depicts an embedded calibrated sensor 1600 that is magnetically attached to the bezel 1602 of the display device 1100. The sensor 1600 can be embodied as a stand-alone calibration element that communicates to the TV via Bluetooth communication or other NFC interfaces. Similar to FIG. 14, the reference data set can be stored in the TV non-volatile memory and the sensor 1600 calibration can be executed using a first-use calibration. In this regard, the raw target data captured by the sensor 1600 can be used to calculate the proper calibration matrix as described with respect to FIG. 13 and the numerical process to establish the calibration matrix. The calibration matrix can be stored display device's 1100 non-volatile memory (i.e., memory 1105 as shown in FIGS. 11A-B). The side view 1604 of the display device 1100 can depict the placement of the sensor 1600.

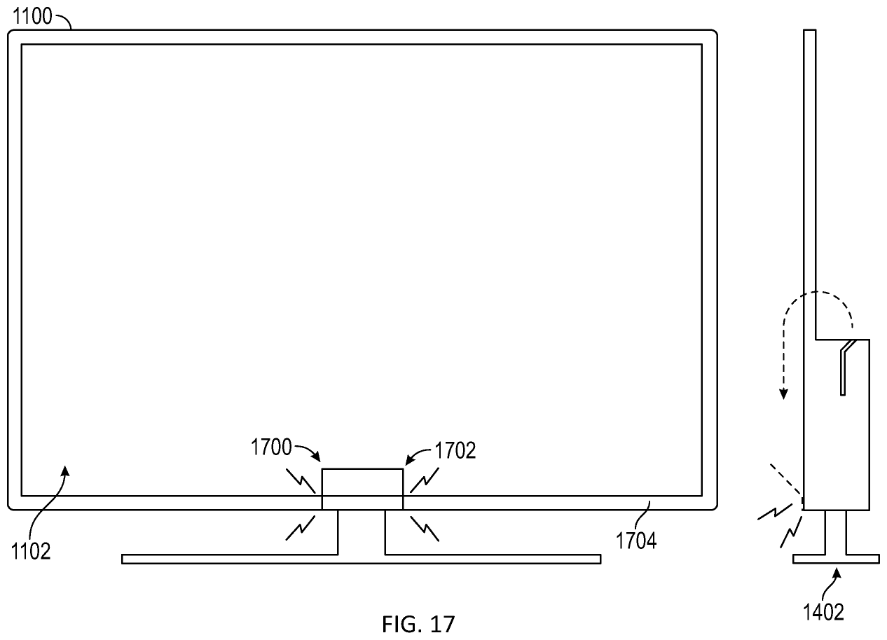

FIG. 17 depicts a mirror periscope 1702 utilizing a sensor 1700 embedded in the bezel 1704 of a display device 1100. In one embodiment, the embedded sensor 1700 can be used for detection of ambient illumination as well as display calibration when the mirror periscope 1702 is attached to the display device 1100 to perform display calibration on the display screen 1102. In this configuration either the fixed factory calibration or the first-use calibration can be implemented in the event the mirror periscope 1702 is not attached to the display device 1100.

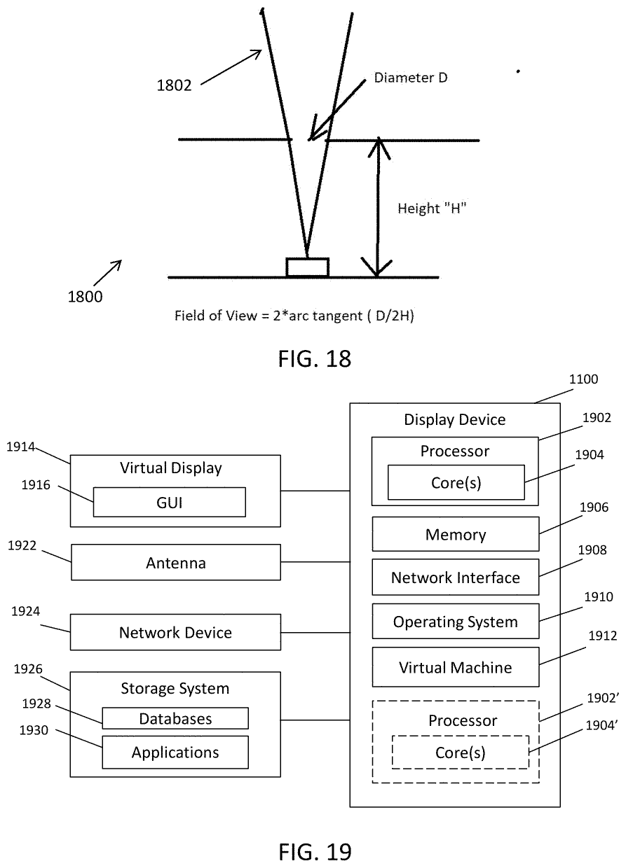

FIG. 18 is a block diagram depicting an exemplary design to minimize viewing angle differences. An exemplary embedded target sensor should directly be relatable to the measurements of a standard reference sensor. Display devices including LCD display screens can change characteristics as a function of viewing angle. It can be important to manage the viewing angle of the target sensor to closely match, or be less than, the viewing angle of the reference sensor. The design 1800 minimizes the viewing angle 1802 differences between the target sensor and the reference sensor.

FIG. 19 is a block diagram of an exemplary device suitable for use in an embodiment. The device 1900 may be, but is not limited to, a smartphone, laptop, tablet, desktop computer, server, or network appliance. The device 1900 can be embodied as part of the computing system or the display device. The device 1900 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 1906 included in the device 1900 may store computer-readable and computer-executable instructions or software (e.g., applications 1930 such as the calibration application) for implementing exemplary operations of the device 1900. The device 1900 also includes configurable and/or programmable processor 1902 and associated core(s) 1904, and optionally, one or more additional configurable and/or programmable processor(s) 1902′ and associated core(s) 1904′ (for example, in the case of computer systems having multiple processors/cores), for executing computer-readable and computer-executable instructions or software stored in the memory 1906 and other programs for implementing exemplary embodiments of the present disclosure. Processor 1902 and processor(s) 1902′ may each be a single core processor or multiple core (1904 and 1904′) processor. Either or both of processor 1902 and processor(s) 1902′ may be configured to execute one or more of the instructions described in connection with device 1900.

Virtualization may be employed in the device 1900 so that infrastructure and resources in the device 1900 may be shared dynamically. A virtual machine 1912 may be provided to handle a process running on multiple processors so that the process appears to be using only one computing resource rather than multiple computing resources. Multiple virtual machines may also be used with one processor.

Memory 1906 may include a computer system memory or random access memory, such as DRAM, SRAM, EDO RAM, and the like. Memory 1906 may include other types of memory as well, or combinations thereof.

The device 1900 can include a virtual display 1914 configured to render a graphical user interface (GUI) 1916. The virtual display 1914 can be embodied as the display screen (e.g., display screen as shown in FIGS. 11A-11B, 14-17). The virtual display 1914 can be multi-touch surface.

The device 1900 may also include one or more computer storage devices 1926, such as a hard-drive, CD-ROM, or other computer readable media, for storing data and computer-readable instructions and/or software that implement exemplary embodiments of the present disclosure (e.g., applications). For example, exemplary storage device 1926 can include one or more databases 1928 for storing information regarding sensor calibration. The databases 1928 may be updated manually or automatically at any suitable time to add, delete, and/or update one or more data items in the databases.

The device 1900 can include a network interface 1908 configured to interface via one or more network devices 1924 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), Near Field Communication (NFC) interfaces such as Bluetooth®, or some combination of any or all of the above. In exemplary embodiments, the computing system can include one or more antennas 1922 to facilitate wireless communication (e.g., via the network interface) between the device 1900 and a network and/or between the device 1900 and other devices. The network interface 1908 may include a built-in network adapter, network interface card, PCMCIA network card, card bus network adapter, wireless network adapter, USB network adapter, modem or any other device suitable for interfacing the device 1900 to any type of network capable of communication and performing the operations described herein. It can be appreciated that the device 1900 can be an Internet of Things (IoT) device.

The device 1900 may run any operating system 1910, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the device 1900 and performing the operations described herein. In exemplary embodiments, the operating system 1910 may be run in native mode or emulated mode. In an exemplary embodiment, the operating system 1910 may be run on one or more cloud machine instances.

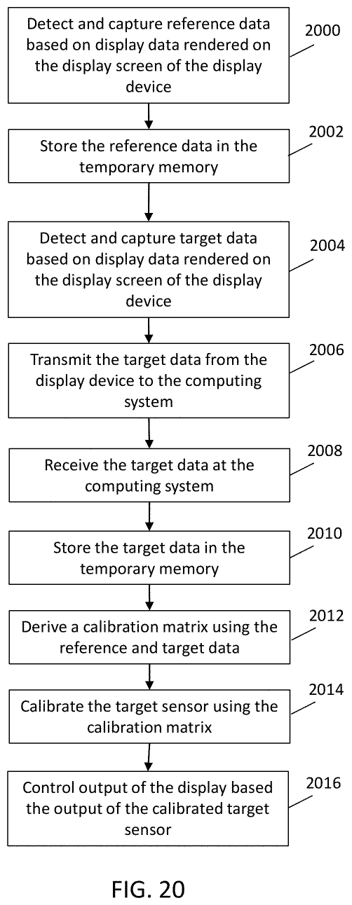

FIG. 20 is a flowchart for implementing the color calibration system according to an exemplary embodiment of the present disclosure. In operation 2000, a reference sensor of a computing system can detect and capture reference data based on display data rendered on the display screen of the display device. The computing system can be in communication with a display device, and can include a processor, persistent memory, temporary memory and execute an instance of a calibration application. In operation 2002, the computing system can store the reference data in the temporary memory. In operation 2004, a target sensor of the display device including non-volatile memory and a display screen can detect and capture target data based on display data rendered on the display screen of the display device. In operation 2006, the display device can transmit the target data to the computing system. In operation 2008, the computing system can receive the target data. In operation 2010, the computing system can store the target data in the temporary memory. In operation 2012, the calibration application of the computing system can derive a calibration matrix using the reference and target data stored in the temporary memory. In operation 2014, the computing system can calibrate the target sensor using the calibration matrix. In operation 2016, the output of the display device is controlled at least on part based on data sensed by the calibrated target sensor.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A color calibration system comprising:
a reference sensor configured to generate reference data in response to sensing display data rendered on a display screen of a display device, the display data including a plurality of luminance patterns and a plurality of color patterns;
a target sensor configured to generate target data in response to the display data rendered on the display screen of the display device;
a processor programmed to:
derive a linear calibration for the target sensor based on luminance data in the reference data and the target data corresponding to the plurality of luminance patterns;
derive a calibration matrix based on color data in the reference and target data corresponding to the plurality of color patterns; and
calibrate the target sensor using the calibration matrix.

2. The system of claim 1, wherein the target data includes color data and near infrared data and reference data includes color data.

3. The system of claim 2, wherein the target sensor includes five channels to capture white, red, green, blue, and near infrared data and the reference sensor include three channels to capture the red, green, and blue data based on the each of the plurality of reference color patterns rendered on the display screen.

4. The system of claim 1, wherein the luminance data in the reference data and target data is generated in response to the plurality of luminance patterns before the plurality of color patterns are rendered on the display screen.

5. The system of claim 1, wherein the plurality of luminance patterns and the plurality of color patterns are specified according to one or more patch sets to maintain an average operational measurement condition of the display screen based upon a specified distribution of luminance values and differences between the luminance values and a median value for the specified distribution.

6. The system of claim 1, further comprising:
a temperature sensor associated with at least one of the reference sensor or target sensor.

7. The system of claim 6, wherein the temperature sensor is integrally formed the reference sensor or the target sensor.

8. The system of claim 6, wherein the processor measures a color drift of the display screen of the display device as a function of an operating temperature of the display screen over a specified period of time and generated a model of the color drift based on the color drift as a function of the operating temperature, wherein the color drift is measured by at least one of the reference sensor or the target sensor and the operating temperature is measured by the temperature sensor.

9. The system of claim 8, wherein the processor corrects for the color drift using the model before each of the plurality of luminance patterns and each of the plurality of color patterns are render on the display screen.

10. The system of claim 1, wherein the system comprises the display device and the processor is included in the display device.

11. The system of claim 1, wherein the system comprises a computing system and the processor is included in the computing device.

12. A color calibration method comprising:
generating, via a reference sensor, reference data in response to sensing display data rendered on a display screen of a display device, the display data including a plurality of luminance patterns and a plurality of color patterns;
generating, via a target sensor, target data in response to the display data rendered on the display screen of the display device;
deriving, via a processing device, a linear calibration for the target sensor based on luminance data in the reference data and the target data corresponding to the plurality of luminance patterns;
deriving, via a processing device, a calibration matrix based on color data in the reference and target data corresponding to the plurality of color patterns; and
calibrating, via the processing device, the target sensor using the calibration matrix.

13. The method of claim 12, wherein the luminance data in the reference data and target data are generated in response to the plurality of luminance patterns before the plurality of color patterns are rendered on the display screen.

14. The method of claim 1, wherein the plurality of luminance patterns and the plurality of color patterns are specified according to one or more patch sets to maintain an average operational measurement condition of the display screen based upon a specified distribution of luminance values and differences between the luminance values and a median value for the specified distribution.

15. The method of claim 12, further comprising:
measuring an operating temperature of the display screen over a specified period of time;
measuring, via at least one of the reference sensor or the target sensor, a color drift of the display screen over the specified period of time; and
generating a model of the color drift, the model corresponding to the measured color drift as a function of the measured operating temperature over the specified period of time.

16. The method of claim 15, wherein the temperature sensor associated with at least one of the reference sensor or target sensor.

17. The system of claim 16, wherein the temperature sensor is integrally formed the reference sensor or the target sensor.

18. The method of claim 17, further comprising:
correcting, via the processor, the color drift using the model before each of the plurality of luminance patterns and each of the plurality of color patterns are render on the display screen.

19. The method of claim 12, wherein the system comprises the display device and the processor is included in the display device.

20. The method of claim 12, wherein the system comprises a computing system and the processor is included in the computing device.

21. A non-transitory computer-readable medium comprising instructions, wherein execution of the instruction by a processor causes the processor to:
store reference data generated by a reference sensor in memory in response to the reference sensor sensing display data rendered on a display screen of a display device, the display data including a plurality of luminance patterns and a plurality of color patterns;
store target data generated by a target sensor in response to the display data rendered on the display screen of the display device;
derive a linear calibration for the target sensor based on luminance data in the reference data and the target data corresponding to the plurality of luminance patterns;
derive a calibration matrix based on color data in the reference and target data corresponding to the plurality of color patterns; and
calibrate the target sensor using the calibration matrix.
